(19) United States
(12) Patent Application Publication
(10) Pub. No.: US 2026/0366274 A1
(43) Pub. Date: Nov. 19, 2026

(54) SHOWERHEAD HANGING STRUCTURE AND SHOWERHEAD STRUCTURE

(71) Applicants: XIAMEN KEEKOE SANITARY WARE CO.,LTD, Xiamen (CN); Shourong HU, Xiamen (CN)

(72) Inventors: Shourong HU, Xiamen (CN); Minmin ZHOU, Xiamen (CN); Tiande LIN, Xiamen (CN)

(73) Assignees: Shourong HU, Xiamen (CN); XIAMEN KEEKOE SANITARY WARE CO.,LTD, Xiamen (CN)

(21) Appl. No.: 19/645,352

(22) Filed: Apr. 13, 2026

(30) Foreign Application Priority Data
May 19, 2025 (CN) 2025209827352

(51) Int. Cl. E03C 1/04; B05B 15/62

(52) U.S. Cl. CPC E03C 1/0408; B05B 15/62

(57) ABSTRACT

This disclosure relates to the technical field of bathroom accessories, and provides a showerhead hanging structure for connecting a showerhead body to a showerhead support. The hanging structure includes a first bracket arranged on the showerhead support and a second bracket arranged on the showerhead body, and the second bracket is detachably connected to the first bracket; and a first buckle is arranged on the first bracket, a clamping groove is arranged on the second bracket, a clamping step for hooking the first buckle is arranged above the clamping groove, a first channel for the first buckle to pass through is arranged at least one side of two sides of the clamping step, and the first channel is in communication with the clamping groove.

### CROSS-REFERENCE TO RELATED APPLICATIONS

The application claims priority to Chinese patent application No. 2025209827352, filed on May 19, 2025, the entire contents of which are incorporated herein by reference.

### TECHNICAL FIELD

This disclosure relates to the technical field of bathroom accessories, and in particular, to a showerhead hanging structure and a showerhead structure.

### BACKGROUND

A showerhead is a common bathing appliance in a bathroom, which generally includes a handle in communication with a water pipe, and a water outlet device mounted at one end of the handle away from the water pipe. A water flow passes through the water pipe, the handle, and water outlet holes on the water outlet device in sequence to be sprayed out.

With the improvement of living quality and the development of industrial technology, daily bathing has become a common practice for every household. Meanwhile, people desire to filter water, so as to reduce damage of raw water (unfiltered tap water) to skin. Some existing filtered showerheads adopt the following structure: a fixed base with a filtering function is provided, and the showerhead is directly hung on the fixed base. The water flow passes through the fixed base and then is connected to the handle of the showerhead through a connecting pipe. The showerhead is adsorbed onto the fixed base by means of magnetic attraction. However, this manner may have the following problems: the showerhead is easy to fall off under an excessively high water pressure or when being touched accidentally, and the fallen showerhead may injure a user or cause damage to the showerhead itself.

Therefore, the inventor specially designed a showerhead hanging structure and a showerhead structure, thus giving rise to this disclosure.

### SUMMARY

To address the technical problems to be solved, this disclosure provides a showerhead hanging structure that overcomes at least one of the defects. The technical solution adopted is as follows:
a showerhead hanging structure for connecting a showerhead body to a showerhead support, where the hanging structure includes a first bracket arranged on the showerhead support and a second bracket arranged on the showerhead body, and the second bracket is detachably connected to the first bracket; and
a first buckle is arranged on the first bracket, a clamping groove is arranged on the second bracket, a clamping step for hooking the first buckle is arranged above the clamping groove, a first channel for the first buckle to pass through is arranged at least one side of two sides of the clamping step, and the first channel is in communication with the clamping groove.

Further, the two sides of the clamping step are each provided with the first channel in communication with the clamping groove.

Further, the first buckle includes a connecting portion and a clamping hook portion arranged at a tail end of the connecting portion and used for hooking the clamping step. When the clamping hook portion hooks the clamping step, the connecting portion is located in the clamping groove.

Further, the clamping hook portion is arranged above the first connecting portion and close to an edge thereof.

Further, a limiting groove is further arranged on an upper end surface of the clamping hook portion, and a protrusion portion matched with the limiting groove is arranged on the second bracket and located on an inner side of the clamping step.

Further, a first adsorption member is arranged on the first bracket, a second adsorption member is arranged on the second bracket, and the first adsorption member and the second adsorption member attract each other.

Further, the first adsorption member and the second adsorption member are both magnetic members and can be magnetically attracted to each other. When a first clamping hook is embedded into the first channel, the second adsorption member is adsorbed onto the first adsorption member, so as to achieve pre-positioning and facilitate subsequent rotation of the showerhead body.

Further, the first adsorption member is arranged on the first bracket through a first housing, and the second adsorption member is arranged on the second bracket through a second housing.

Further, the first bracket is provided with a first mounting position for placing a first housing with the first adsorption member, and the second bracket is provided with a second mounting position for placing a second housing with the second adsorption member.

Further, a decorative cover is further arranged on the first bracket.

Further, an annular boss is arranged on an inner side of the first bracket, and a placement groove for the annular step to be embedded is arranged on the second bracket.

This disclosure further provides a showerhead structure adopting the configuration of the showerhead hanging structure.

Further, the showerhead structure further includes a showerhead support and a showerhead main body, the first bracket is locked to the showerhead support through a plurality of first screws, and the second bracket is locked to the showerhead main body through a plurality of second screws.

The showerhead hanging structure of this disclosure adopts the cooperation of the first buckle and the clamping step to achieve the connection between the showerhead main body and the showerhead support. Specifically, when the showerhead body is hung, the first buckle passes through the first channel, rotates into the clamping groove and hooks the clamping step through the first buckle. When the showerhead body needs to be removed, the first buckle is rotated into the first channel, and then the showerhead body can be removed from the showerhead support. Therefore, the showerhead main body after hanging can be better and more stably restricted or mounted on the showerhead support, avoiding problems caused by falling.

### BRIEF DESCRIPTION OF THE DRAWINGS

The accompanying drawings illustrated herein are used to provide further understanding of this disclosure, thereby forming a part of this disclosure, but not constituting inappropriate limitations of this disclosure.

In the accompanying drawings:

FIG. 1 is an axonometric schematic view of a showerhead hanging structure of this disclosure;

FIG. 2 is a usage schematic view of a showerhead hanging structure of this disclosure;

FIG. 3 is a cross-sectional schematic view of a showerhead hanging structure of this disclosure;

FIG. 4 is an axonometric schematic view of a first bracket of this disclosure;

FIG. 5 is an axonometric schematic view of a second bracket of this disclosure;

FIG. 6 is an installation schematic view of a first bracket of this disclosure;

FIG. 7 is an installation schematic view of a second bracket of this disclosure;

FIG. 8 is an exploded schematic view of a showerhead structure of this disclosure; and

FIG. 9 is a partial exploded schematic view of a showerhead structure of this disclosure.

### REFERENCE NUMERALS

001. showerhead support; 002. showerhead body; 100. first bracket; 110. first buckle; 111. connecting portion; 112. clamping hook portion; 1121. limiting groove; 120. annular step; 130. positioning groove; 200. second bracket; 210. clamping groove; 211. clamping step; 220. first channel; 230. protrusion portion; 240. placement groove; 300. first adsorption member; 400. second adsorption member; 500. first housing; 600. second housing; 700. decorative cover.

### DETAILED DESCRIPTION OF THE EMBODIMENTS

In order to enable a person skilled in the art to better understand the technical solutions of this disclosure, the technical solutions in the embodiments of this disclosure will be clearly and completely described below with reference to the accompanying drawings in the embodiments of this disclosure. Apparently, the described embodiments are only some rather than all of the embodiments of this disclosure. All other embodiments obtained by those of ordinary skill in the art based on the embodiments of this disclosure without creative efforts shall fall within the protection scope of this disclosure.

### Embodiment 1

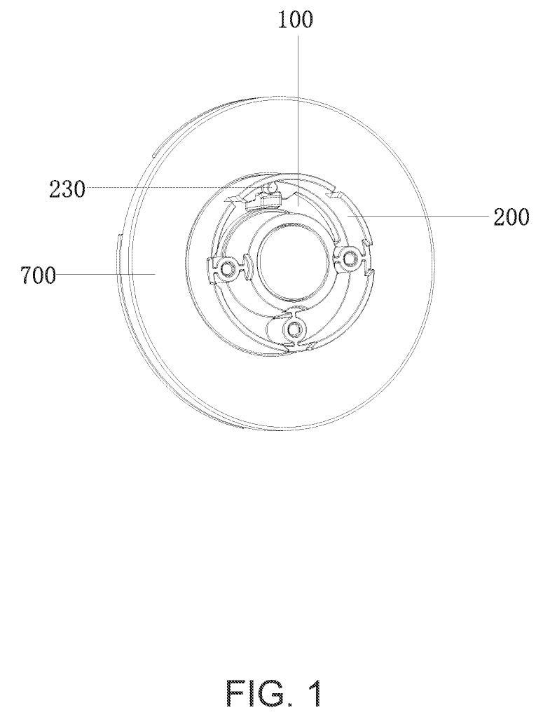

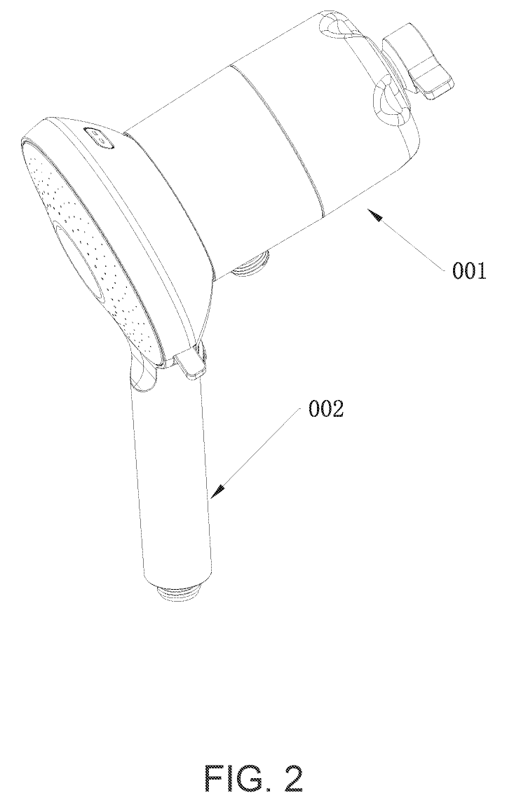

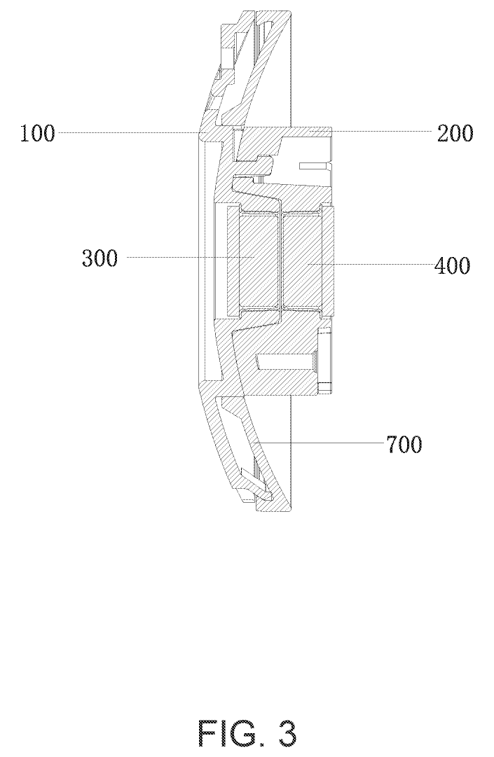

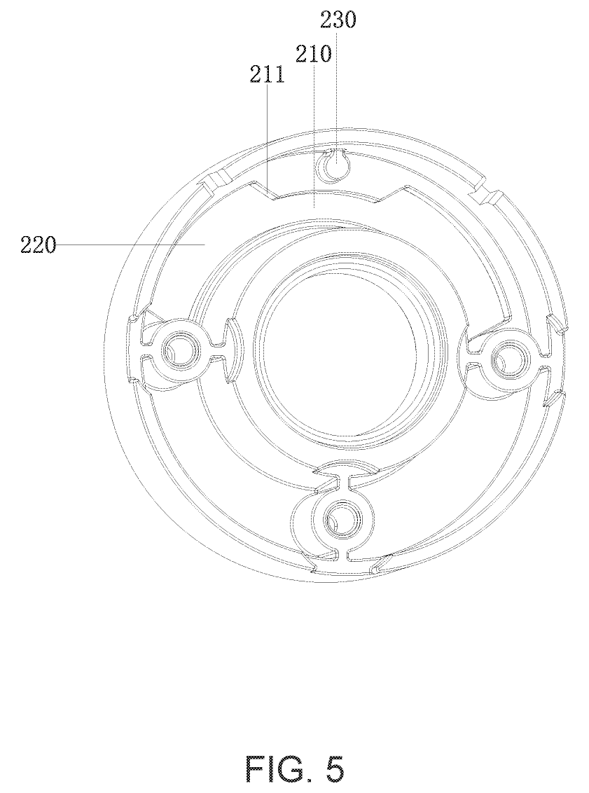

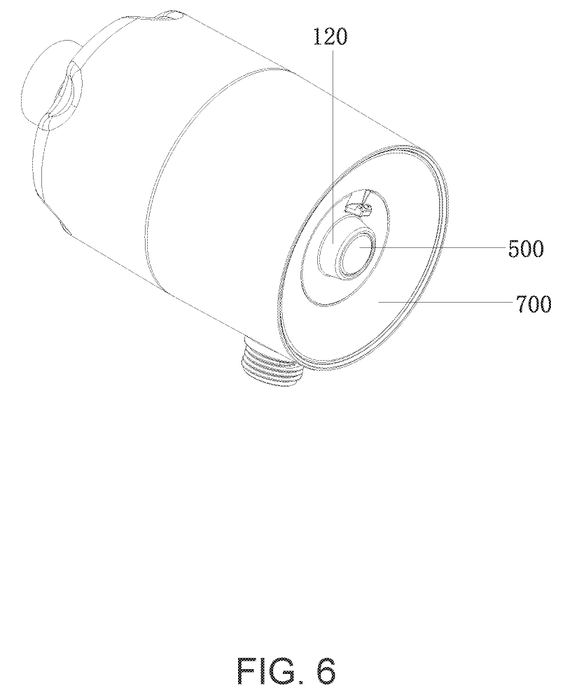

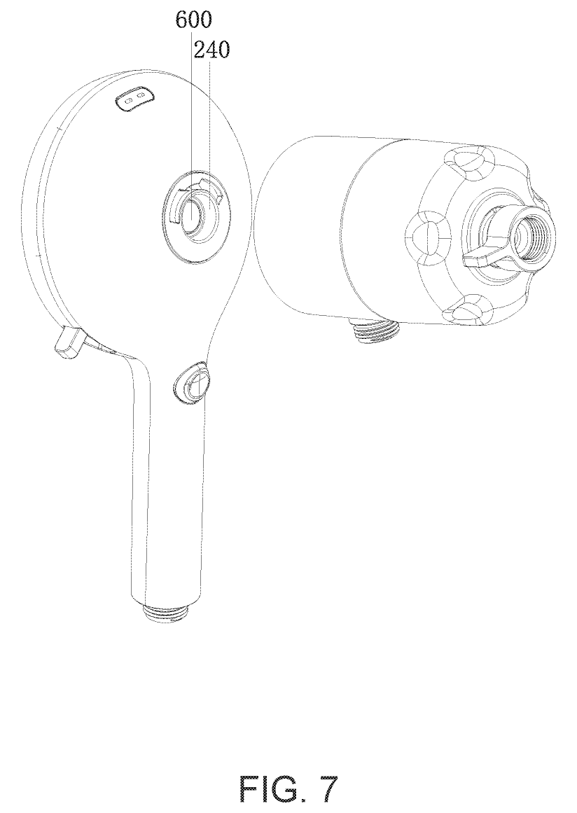

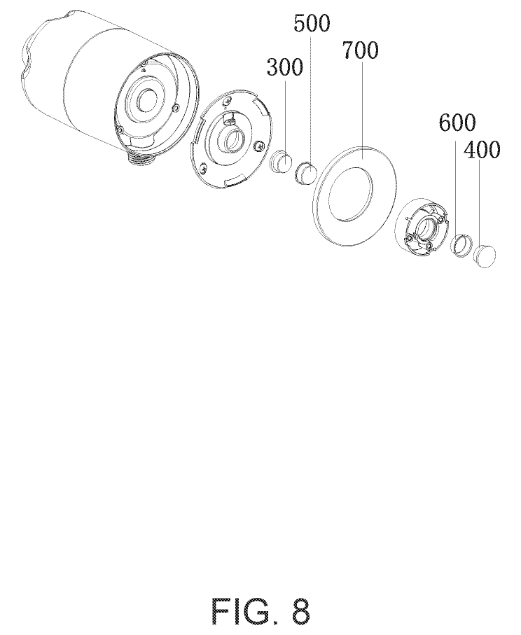

Please refer to FIGS. 1-FIGS.9, which illustrate a showerhead hanging structure provided in Embodiment 1 of this disclosure, for connecting a showerhead body 002 to a showerhead support 001. The hanging structure includes a first bracket 100 arranged on the showerhead support 001 (or a fixed base with a filtering function) and a second bracket 200 arranged on the showerhead body 002, and the second bracket 200 is detachably connected to the first bracket 100; and a first buckle 110 is arranged on the first bracket 100, a clamping groove 210 is arranged on the second bracket 200, a clamping step 211 for hooking the first buckle 110 is arranged above the clamping groove 210, a first channel 220 for the first buckle 110 to pass through is arranged at least one side of two sides of the clamping step 211, and the first channel 220 is in communication with the clamping groove 210.

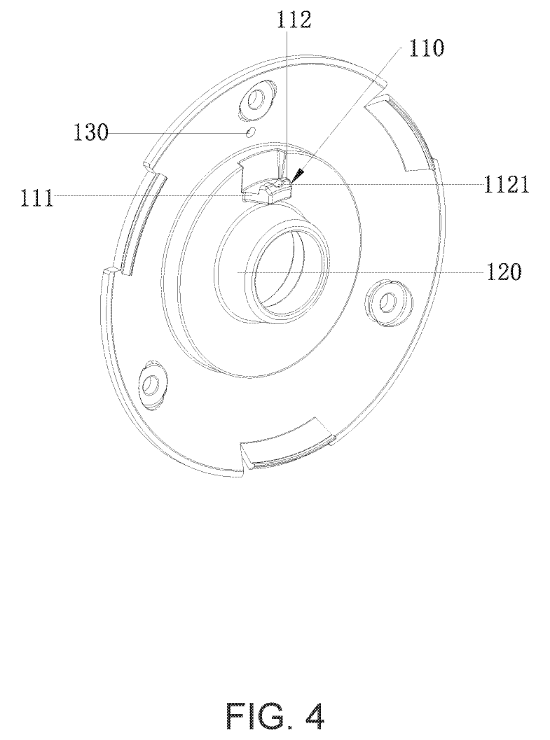

Please refer to FIG. 4, to enable hanging of the showerhead main body on the showerhead support 001 from both sides, two sides of the clamping step 211 are each provided with the first channel 220 in communication with the clamping groove 210. Specifically, the two sides of the clamping step 211 are each provided with the first channel 220, so as to facilitate mounting of the showerhead body 002 from both sides and also facilitate removal of the showerhead body 002 from both sides. In this disclosure, the clamping groove 210 and the first channel 220 are arc-shaped as a whole, so that when the showerhead main body is mounted or removed, the first buckle 110 is located in the clamping groove 210 and rotates in the first channel 220.

The first buckle 110 includes a connecting portion 111 and a clamping hook portion 112 arranged at a tail end of the connecting portion 111 and used for hooking the clamping step 211. When the clamping hook portion 112 hooks the clamping step 211, the connecting portion 111 is located in the clamping groove 210. Specifically, the clamping hook portion 112 is arranged above the first connecting portion 111 and close to an edge thereof. To further improve stable hanging of the showerhead main body, a limiting groove 1121 is further arranged on an upper end surface of the clamping hook portion 112, and a protrusion portion 230 matched with the limiting groove 1121 is arranged on the second bracket 200 and located on an inner side of the clamping step 211. When the clamping hook portion 112 hooks the clamping step 211, the protrusion portion 230 is embedded into the clamping groove 210 to prevent the showerhead body 002 from rotating automatically, so that the showerhead main body is better arranged on the showerhead support 001. The limiting groove 1121 is arc-shaped, and a lower part of the corresponding protrusion portion 230 is cylindrical, so as to facilitate cooperation with the arc-shaped limiting groove 1121. In this embodiment, both the first bracket 100 and the second bracket 200 are plastic members and integrally formed by an injection molding process. Meanwhile, the connecting portion 111 is similar to an elastic support arm, so that after the showerhead main body is hung on the showerhead support 001, the showerhead main body can be removed only when a certain external force is applied.

A first adsorption member 300 is arranged on the first bracket 100, a second adsorption member 400 is arranged on the second bracket 200, and the first adsorption member 300 and the second adsorption member 400 attract each other. Specifically, the first adsorption member 300 and the second adsorption member 400 are both magnetic members and can be magnetically attracted to each other. When a first clamping hook is embedded into the first channel 220, the second adsorption member 400 is adsorbed onto the first adsorption member 300, so as to achieve pre-positioning and facilitate subsequent rotation of the showerhead body 002. The first adsorption member 300 is arranged on the first bracket 100 through a first housing 500, and the second adsorption member 400 is arranged on the second bracket 200 through a second housing 600. Further, the first bracket 100 is provided with a first mounting position for placing the first housing 500 with the first adsorption member 300, and the second bracket 200 is provided with a second mounting position for placing the second housing 600 with the second adsorption member 400. The first housing 500 and the second housing 600 can be made of metal material. Inner sides of the first mounting position and the second mounting position are in a stepped shape to prevent the first housing and the second housing from falling off. Meanwhile, a cushion block can be arranged to press the first adsorption member and the first housing, or the second adsorption member and the second housing. The cushion block can be made of rubber or silicone material. After the first bracket or the second bracket is locked, the cushion block is compressed and pressure is generated.

In this embodiment, a decorative cover 700 is further arranged on the first bracket 100. The arrangement of the decorative cover 700 makes the overall appearance more aesthetic.

An annular boss is arranged on an inner side of the first bracket 100, and a placement groove 240 for the annular step 120 to be embedded is arranged on the second bracket 200. The annular step 120 and the placement groove 240 facilitate rotation of the showerhead main body. Specifically, the first mounting position is located on an inner side of the annular step 120, and the second mounting position is located at the bottom of the placement groove 240.

The showerhead support 001 is further provided with a positioning column, and the first bracket 100 is provided with a positioning groove 130 for cooperating with the positioning column. The positioning groove 130 cooperates with the positioning column to prevent incorrect mounting of the first bracket 100. After positioning, the clamping hook portion 112 of the first buckle 110 is located above the first connecting portion 111.

### Embodiment 2

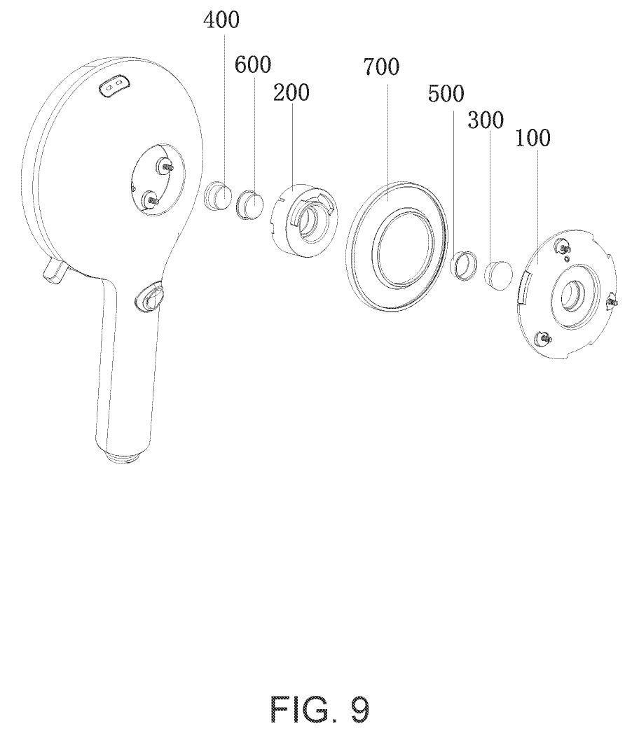

Please refer to FIGS. 1 - FIG. 9, which illustrate a showerhead hanging structure provided as Embodiment 2 of this disclosure, and a showerhead structure adopting the configuration of the showerhead hanging structure. The showerhead structure further includes a showerhead support 001 and a showerhead main body. The showerhead support 001 has a filtering function, and the water flow is connected to the showerhead main body through a connecting pipe. The first bracket 100 is locked to the showerhead support 001 through a plurality of first screws, and the second bracket 200 is locked to the showerhead main body through a plurality of second screws. Specifically, the plurality of first screws pass through the first bracket 100 and are then locked to the showerhead support 001. Therefore, the arranged decorative cover 700 can cover the first screws, making the overall appearance more aesthetic. The second screws pass through an outer housing of the showerhead main body and are then screwed to the second bracket 200. Therefore, the first housing 500 with the first adsorption member 300 is first placed in the first bracket 100 and then locked by the first screws, so that the first adsorption member 300 is confined on the first bracket 100; and the second housing 600 with the second adsorption member 400 is placed in the second bracket 200 and then locked by the second screws, so that the second adsorption member 400 is confined on the second bracket 200.

The hanging principle of the showerhead main body of this disclosure is as follows:
When the showerhead main body is hung on the showerhead support 001, a user holds the showerhead body 002 and then rotates it (a rotation direction can be selected according to usage habits). The protrusion portion 230 is first disengaged from the limiting groove 1121, and then the first buckle 110 is rotated into the first channel 220, so that the showerhead main body can be removed outwards.
When the removed showerhead main body is to be hung on the showerhead support 001, the first buckle 110 is inserted corresponding to the first channel. After rotating a certain angle, the connecting portion 111 is rotated into the clamping groove 210, and the protrusion portion 230 is embedded into the limiting groove 1121.

In conclusion, the showerhead hanging structure of this disclosure adopts the cooperation of the first buckle and the clamping step to achieve the connection between the showerhead main body and the showerhead support. Specifically, when the showerhead body is hung, the first buckle passes through the first channel, rotates into the clamping groove and hooks the clamping step through the first buckle. When the showerhead body needs to be removed, the first buckle is rotated into the first channel, and then the showerhead body can be removed from the showerhead support. Therefore, the showerhead main body after hanging can be better and more stably restricted or mounted on the showerhead support, avoiding problems caused by falling.

It should be understood that this disclosure is not limited to the precise structure described above and shown in the accompanying drawings, and various modifications and changes can be made without departing from its scope. The scope of this disclosure is limited only by the appended claims.

What is claimed is:

1. A showerhead hanging structure for connecting a showerhead body to a showerhead support, wherein the hanging structure comprises a first bracket arranged on the showerhead support and a second bracket arranged on the showerhead body, and the second bracket is detachably connected to the first bracket; and
a first buckle is arranged on the first bracket, a clamping groove is arranged on the second bracket, a clamping step for hooking the first buckle is arranged above the clamping groove, a first channel for the first buckle to pass through is arranged at least one side of two sides of the clamping step, and the first channel is in communication with the clamping groove.

2. The showerhead hanging structure according to claim 1, wherein the two sides of the clamping step are each provided with the first channel in communication with the clamping groove.

3. The showerhead hanging structure according to claim 1, wherein the first buckle comprises a connecting portion and a clamping hook portion arranged at a tail end of the connecting portion and used for hooking the clamping step.

4. The showerhead hanging structure according to claim 3, wherein a limiting groove is further arranged on an upper end surface of the clamping hook portion, and a protrusion portion matched with the limiting groove is arranged on the second bracket and located on an inner side of the clamping step.

5. The showerhead hanging structure according to claim 1, wherein a first adsorption member is arranged on the first bracket, a second adsorption member is arranged on the second bracket, and the first adsorption member and the second adsorption member attract each other.

6. The showerhead hanging structure according to claim 5, wherein the first adsorption member is arranged on the first bracket through a first housing, and the second adsorption member is arranged on the second bracket through a second housing.

7. The showerhead hanging structure according to claim 1, wherein a decorative cover is further arranged on the first bracket.

8. The showerhead hanging structure according to claim 1, wherein an annular boss is arranged on an inner side of the first bracket, and a placement groove for the annular step to be embedded is arranged on the second bracket.

9. A showerhead structure, adopting the showerhead hanging structure according to claim 1.

10. The showerhead structure according to claim 9, wherein the showerhead structure further comprises a showerhead support and a showerhead main body, the first bracket is locked to the showerhead support through a plurality of first screws, and the second bracket is locked to the showerhead main body through a plurality of second screws.
